(19) United States
(12) Patent Application Publication
(10) Pub. No.: US 2015/0326085 A1
(43) Pub. Date: Nov. 12, 2015

(54) ROTOR FOR WOUND-ROTOR INDUCTION MOTOR HAVING ANTI-SPATTERING MEMBERS

(71) Applicant: MANDO CORPORATION, Pyeongtaek-si (KR)

(72) Inventor: Chung Seong LEE, Uiwang-Si (KR)

(73) Assignee: MANDO CORPORATION, Pyeongtaek-si (KR)

(21) Appl. No.: 14/706,711

(22) Filed: May 7, 2015

(30) Foreign Application Priority Data
May 9, 2014 (KR) 10-2014-0055940

(51) Int. Cl. H02K 3/32

(52) U.S. Cl. CPC H02K 3/325

(57) ABSTRACT

Provided is a rotor for a wound-rotor induction motor having anti-spattering members. The rotor includes: a core that includes a base part having a hollow into which a shaft of the rotor is inserted, a plurality of winding parts that extend outward from a circumference of the base part and are spaced a predetermined distance from one another, and a plurality of panel parts that are provided at ends of the winding parts and are wider than the winding parts; coils wound around the winding parts; and anti-spattering members which are in contact with the panel parts and each of which is provided between the pair of winding parts adjacent to each other and prevents the coils adjacent to each other from spattering.

### CROSS-REFERENCE TO RELATED APPLICATION

This application claims the benefit of Korean Patent Application No. 10-2014-0055940, filed on May 9, 2014, the disclosure of which is hereby incorporated herein by reference in its entirety.

### BACKGROUND OF THE INVENTION

1. Field of the Invention

The present invention relates generally to a rotor for a wound-rotor induction motor and, more particularly, to a rotor for a wound-rotor induction motor having anti-spattering members for preventing spattering of coils.

2. Description of the Related Art

In hybrid vehicles, an integrated starter generator (ISG) that is an electric motor that serves to start an engine, assist with torque of the engine, and generate electricity is generally provided at a position of an existing alternator of the vehicle. Various motors may be used for such an ISG. Among them, a wound-rotor induction motor is broadly used.

Coils are wound around a rotor of such a wound-rotor induction motor to generate magnetic flux, and brushes and slip rings are provided outside a motor housing to generate the magnetic flux. An electric current is applied to the brushes and the slip rings.

However, the wound-rotor induction motor has a problem in that the coils are very likely to spatter because there is no structure for fixing the rotor in an axial direction. If any coil spatters, rotation of the rotor is out of balance, and dielectric breakdown of the coil occurs. As a result, the coil is reduced in performance or cannot be used.

Therefore, reliability of the coil structure of the rotor is reduced.

Accordingly, a solution to the problems is required.

### DOCUMENTS OF RELATED ART

Patent Document 1) Korean Unexamined Patent Application Publication No. 10-2011-0138311

### SUMMARY OF THE INVENTION

A rotor for a wound-rotor induction motor having anti-spattering members according to the present invention is intended to solve a problem of spattering of coils due to rotation of the rotor.

Thus, the rotor for the wound-rotor induction motor having the anti-spattering members according to the present invention is also intended to improve reliability of the motor.

However, the problems to be solved by the present invention are not limited to the aforementioned problems, and other unmentioned problems can be clearly understood by those skilled in the art from the following description.

To address the problem, the present invention provides a rotor for a wound-rotor induction motor having anti-spattering members, which includes: a core that includes a base part having a hollow into which a shaft of the rotor is inserted, a plurality of winding parts that extend outward from a circumference of the base part and are spaced a predetermined distance from one another, and a plurality of panel parts that are provided at ends of the winding parts and are wider than the winding parts; coils wound around the winding parts; and anti-spattering members which are in contact with the panel parts and each of which is provided between the pair of winding parts adjacent to each other and prevents the coils adjacent to each other from spattering.

Here, the anti-spattering members may each be formed to be in contact with the pair of coils adjacent to each other.

Further, each of the anti-spattering members may include: an insert that is inserted between the pair of panel parts adjacent to each other; and a fixture which is connected to the insert and both ends of which are in contact with the pair of coils adjacent to each other.

Meanwhile, the rotor for the wound-rotor induction motor may further include insulating members, each of which is provided inside from each of the anti-spattering members and has a dielectric characteristic.

Further, the rotor for the wound-rotor induction motor may further include end plates that are provided at opposite sides of the core and close the opposite sides of the core.

Further, each of the anti-spattering members may be formed with fixing protrusions at opposite sides thereof, and each of the end plates may be formed with insertion holes into which the fixing protrusions are inserted.

Also, at least one of the insertion holes may include an expansion that expands to allow a molding material to be injected thereinto.

In addition, the base part may have rotor weight holes formed in a surface thereof to adjust rotational balance of the rotor.

The rotor for the wound-rotor induction motor having the anti-spattering members according to the present invention has the following effects.

First, the anti-spattering members are provided inside the core, and spattering of the coils due to rotation of the rotor can be prevented.

Second, as a result, reliability of the motor can be improved.

Third, since the coils are prevented from spattering, the rotational balance of the rotor can be stably maintained.

The effects of the present invention are not limited to the aforementioned effects, and other unmentioned effects can be clearly understood by those skilled in the art from the following description.

### BRIEF DESCRIPTION OF THE DRAWINGS

The foregoing and other objects, features and advantages of the invention will become more apparent from the following more particular description of exemplary embodiments of the invention and the accompanying drawings. The drawings are not necessarily to scale, emphasis instead being placed upon illustrating the principles of the invention.

FIG. 1 is a perspective view illustrating an overall shape of a rotor for a wound-rotor induction motor according to an embodiment of the present invention;

FIG. 2 is an exploded perspective view illustrating a structure of the rotor for the wound-rotor induction motor according to the embodiment of the present invention;

FIG. 3 is a side view illustrating a shape of a core in the rotor for the wound-rotor induction motor according to the embodiment of the present invention;

FIG. 4 is a perspective view illustrating a shape of each anti-spattering member in the rotor for the wound-rotor induction motor according to the embodiment of the present invention;

FIG. 5 is a perspective view illustrating a shape in which the anti-spattering members are provided in the core in the rotor for the wound-rotor induction motor according to the embodiment of the present invention;

FIG. 6 is a side view illustrating a shape of each end plate in the rotor for the wound-rotor induction motor according to the embodiment of the present invention; and

FIG. 7 is a perspective view illustrating a shape in which the end plate and the anti-spattering member are coupled in the rotor for the wound-rotor induction motor according to the embodiment of the present invention.

### DETAILED DESCRIPTION OF THE INVENTION

Hereinafter, an exemplary embodiment of the present invention, an object of which can be specifically accomplished, will be described in detail with reference to the drawings. In description of the present embodiment, the same components are given the same names and symbols, and additional description thereof will be omitted.

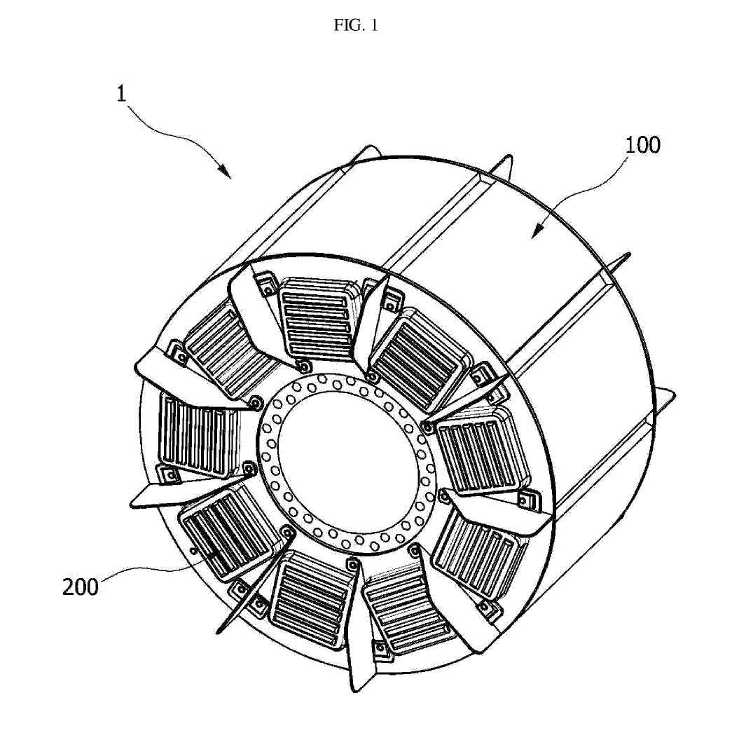

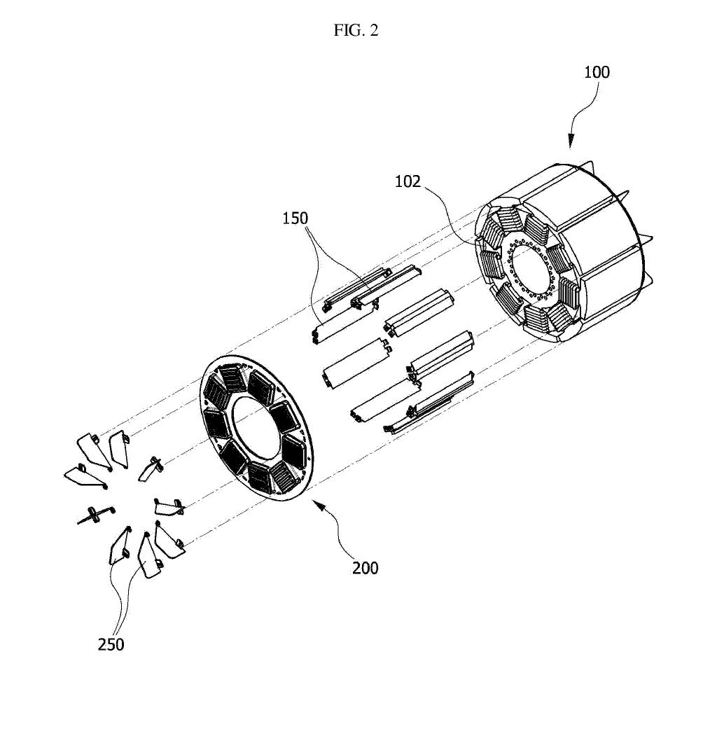

FIG. 1 is a perspective view illustrating an overall shape of a rotor 1 for a wound-rotor induction motor according to an embodiment of the present invention, and FIG. 2 is an exploded perspective view illustrating a structure of the rotor 1 for the wound-rotor induction motor according to the embodiment of the present invention.

As illustrated in FIG. 1, a rotor 1 for a wound-rotor induction motor according to an embodiment of the present invention includes a core 100 and end plates 200. To be more specific, referring to FIG. 2, the core 100 is provided with anti-spattering members 150, and the end plates 200 are each provided with rotor fins 250 for improving heat radiation efficiency.

The end plates 200 are components that are installed on the opposite sides of the core 100 and close the opposite sides of the core 100. The anti-spattering members 150 are components that are provided in first housing spaces 102 in the core 100 and prevent coils from spattering. Details of these components will be described below.

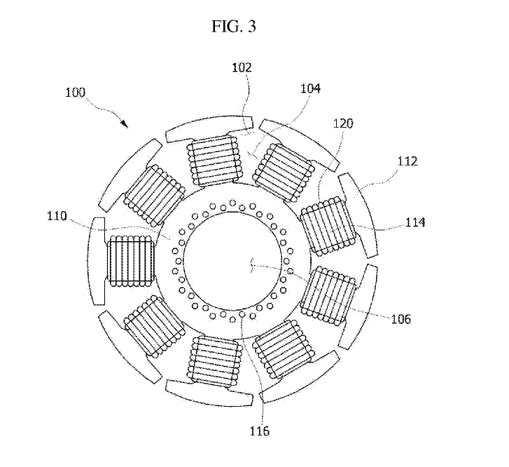

FIG. 3 is a side view illustrating a shape of the core 100 in the rotor for the wound-rotor induction motor according to the embodiment of the present invention.

Referring to FIG. 3, the core 100 includes a base part 110 having a hollow 106 into which a shaft of the rotor is inserted, a plurality of winding parts 114 that extend outward from a circumference of the base part 110 and are spaced a predetermined distance from one another, and a plurality of panel parts 112 that are provided at ends of the winding parts 114 and are wider than the winding parts 114.

In the present embodiment, the plurality of winding parts 114 radially extend from the base part 110, and housing spaces are each defined by the neighboring winding parts 114 and the neighboring panel parts 112. The housing spaces include the first housing spaces 102 interposed between the panel parts 112 and second housing spaces 104 interposed between the winding parts 114. Thereafter, the anti-spattering members are inserted into the first housing spaces 102, and a molding material may be injected into the second housing spaces 104.

Further, rotor weight holes 116 may be formed in a surface of the base part 110. The rotor weight holes 116 are a plurality of holes that are formed to be able to assemble weights for adjusting rotational balance of the rotor after the rotor is finally assembled. Due to the rotor weight holes 116, the rotational balance of the rotor can be easily adjusted, and weight of the rotor can be reduced.

Further, coils 120 are wound around the winding parts 114. Here, when the rotor rotates, the coils 120 may spatter. For this reason, in the present embodiment, the anti-spattering members are provided.

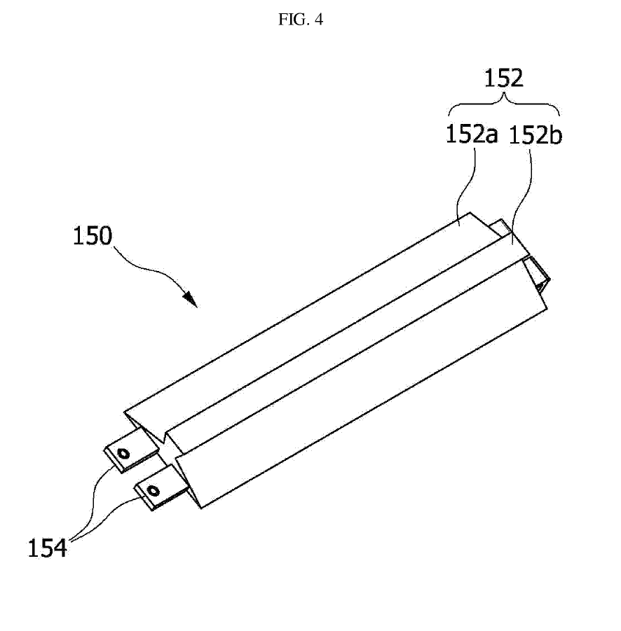

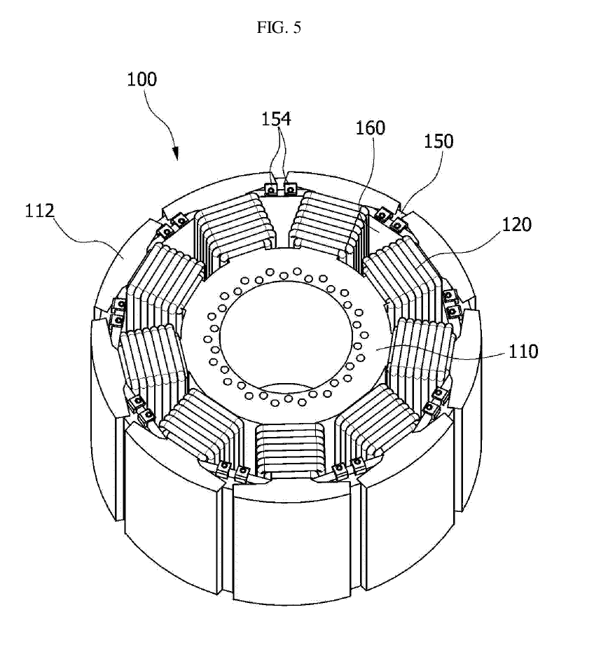

FIG. 4 is a perspective view illustrating a shape of each anti-spattering member 150 in the rotor for the wound-rotor induction motor according to the embodiment of the present invention. FIG. 5 is a perspective view illustrating a shape in which the anti-spattering members 150 are provided in the core 100 in the rotor for the wound-rotor induction motor according to the embodiment of the present invention.

As illustrated in FIGS. 4 and 5, the anti-spattering members 150 are each made up of a body 152 including an insert 152b that is inserted between the pair of panel parts 112 adjacent to each other and a fixture 152a that is connected to the insert 152b and is inserted with both ends thereof in a widthwise direction abutted by or separated from the pair of coils 120 adjacent to each other. Therefore, the anti-spattering members 150 can physically prevent the coils 120 from spattering outward.

Especially, in the present embodiment, the insert 152b is formed such that a width thereof is increased upward, and can be stably fitted and fixed between the panel parts 112.

Fixing protrusions 154 are formed at both sides of the anti-spattering member 150 in a lengthwise direction. The fixing protrusions 154 are components that are provided to be able to be coupled with the end plates 200, and details thereof will be described below.

Meanwhile, in the state in which each anti-spattering member 150 is inserted into the core 100 with a gap from each coil 120, an insulating member 160 having a dielectric characteristic may be further provided inside from the anti-spattering member 150. The insulating member 160 serves to prevent the anti-spattering member 150 and the coil 120 from being electrically connected to each other.

In this case, the anti-spattering member 150 may be formed of a light metal such as aluminum, and the insulating member 160 may be formed of a paper or resin material to protect the coil.

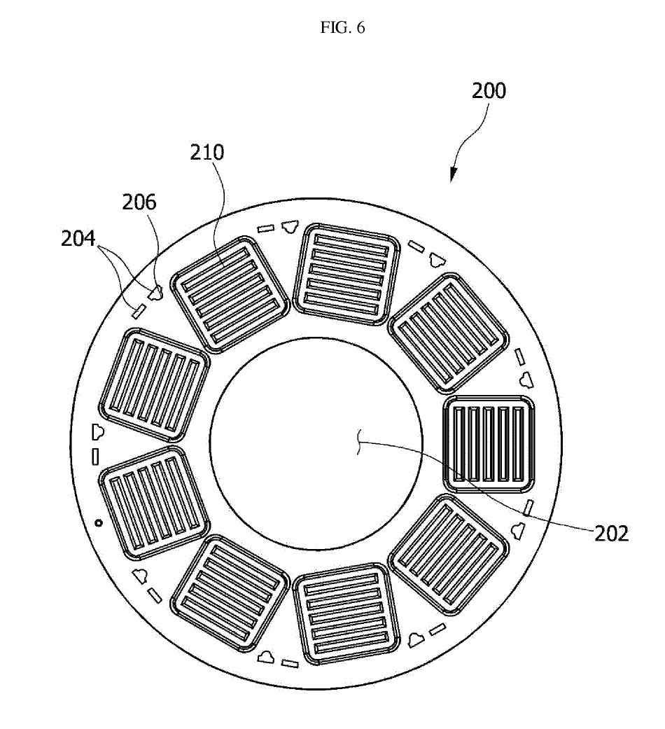

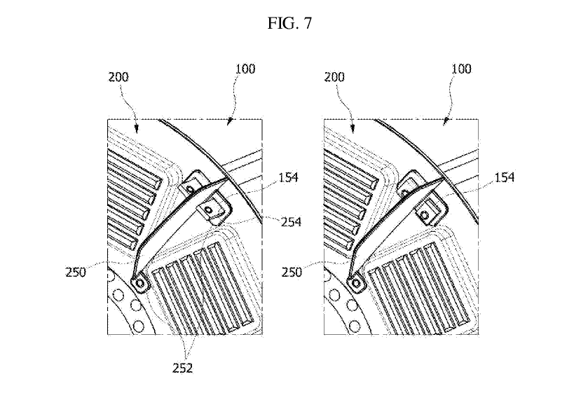

FIG. 6 is a side view illustrating a shape of the end plate 200 in the rotor for the wound-rotor induction motor according to the embodiment of the present invention. FIG. 7 is a perspective view illustrating a shape in which the end plate 200 and the anti-spattering member 150 are coupled in the rotor for the wound-rotor induction motor according to the embodiment of the present invention.

As illustrated in FIGS. 6 and 7, the end plate 200 has a shape corresponding to a side of the core 100, and is formed in a circular shape in the present embodiment. The end plate 200 is provided with a plurality of heat radiators 210 for radiating heat on a surface thereof, and a through-hole 202 through which a shaft of the rotor passes in the center thereof.

The heat radiators 210 protrude from a surface of the end plate 200, and are formed to be able to house end-turns of the coils 120 therein. For this reason, the heat radiators 201 outwardly radiate heat generated from the coils 120 housed inside the core toward the outside.

Further, insertion holes 204 into which the aforementioned fixing protrusions 154 of the anti-spattering members 150 are inserted are formed along a circumference of the end plate 200.

That is, the fixing protrusions 154 of the anti-spattering members 150 inserted into the core 100 protrude from the opposite sides of the core 100, and can be inserted into the insertion holes 204 in the process of coupling the end plates 200 to the core 100.

After the fixing protrusions 154 are inserted into the insertion holes 204, the end plates 200 may be fixed by bending the fixing protrusions 154. That is, the anti-spattering members 150 serve to prevent the coils from spattering, and simultaneously to fix the end plates 200.

Meanwhile, at least one of the paired insertion holes 204 of the end plates 200 includes an expansion 206 that expands such that the molding material can be injected therein. The expansion 206 has an extra area in the state in which the fixing protrusions 154 of the anti-spattering members 150 are inserted into the insertion holes 204, and the molding material can be injected into the aforementioned second housing spaces through the expansions 206.

Meanwhile, the rotor fins 250 are attached to the surfaces of the end plates 200 in a projected state, and rotate along with the rotor 1. Thus, when the present invention is applied to the motor and rotates, the rotor fins 250 radiate heat generated from the stator. The plurality of rotor fins 250 may each be installed between the heat radiators 210, for instance, in a trapezoidal shape.

Further, the rotor fins 250 may each be provided with pairs of rotor fin fixtures 252. The plurality of pairs of rotor fin fixtures 252 are formed to be able to fix the rotor fins 250 to the end plates 200. At least one of each pair of rotor fin fixtures 252 may be provided with fixture insertion holes 254.

The fixture insertion holes 254 are formed such that the fixing protrusions 154 can be inserted thereinto. That is, the fixture insertion holes 254 are disposed at positions corresponding to the insertion holes 204, and the fixing protrusions 154 are inserted into the fixture insertion holes 254 along with the insertion holes 204 at the same time. For this reason, when the fixing protrusions 154 are bent in the inserted state, the rotor fins 250 are each fixed together with the end plates 200, and the rotor fins 250 are easily attached to the end plates 200.

Further, the fixture insertion holes 254 maybe formed to correspond to size of the insertion holes 204 and the expansions 206.

A method of injecting a molding solution into the spaces inside the rotor 1 of the present invention is as follows. The anti-spattering members 150, one end plate 200, and the rotor fins 250 are welded for one side of the rotor 1, and then the fixing protrusions 154 of the anti-spattering members 150 pass through the insertion holes 204 of the other end plate 200 for the other side of the rotor 1, and the other end plate 200 is pressed with a predetermined force. Afterwards, the molding solution is injected through the expansions 206 using a plurality of molding solution injectors.

After the molding solution hardens, the other end plate 200, the fixing protrusions 154, and the rotor fins 250 are welded for the other side of the rotor 1, and the rotor fins 250 can be fixed.

As the molding solution, a molding solution having a high endothermic characteristic may be used to facilitate heat radiation of the coils.

The embodiment described in the present specification and the attached drawings are merely illustrative for describing part of the technical spirit included in the present invention. Accordingly, the embodiment disclosed in the present specification is not intended to be limiting but is merely a description of the technical spirit of the present invention. Thus, it is apparent that the scope of the technical spirit of the present invention is not limited by this embodiment. It should be interpreted that other modifications and specific embodiments which those with ordinary knowledge in the art can easily infer within the scope of the technical spirit included in the specification and drawings of the present invention also fall within the technical scope of the present invention.

What is claimed is:

1. A rotor for a wound-rotor induction motor comprising:
a core that includes a base part having a hollow into which a shaft of the rotor is inserted, a plurality of winding parts that extend outward from a circumference of the base part and are spaced a predetermined distance from one another, and a plurality of panel parts that are provided at ends of the winding parts and are wider than the winding parts;
coils wound around the winding parts; and
anti-spattering members which are in contact with the panel parts, and each of which is provided between the pair of winding parts adjacent to each other and prevents the coils adjacent to each other from spattering.

2. The rotor for the wound-rotor induction motor according to claim 1, wherein the anti-spattering members are each formed to be in contact with the pair of coils adjacent to each other.

3. The rotor for the wound-rotor induction motor according to claim 2, wherein each of the anti-spattering members includes:
an insert that is inserted between the pair of panel parts adjacent to each other; and
a fixture which is connected to the insert and both ends of which are in contact with the pair of coils adjacent to each other.

4. The rotor for the wound-rotor induction motor according to claim 1, further comprising insulating members, each of which is provided inside from each of the anti-spattering members and has a dielectric characteristic.

5. The rotor for the wound-rotor induction motor according to claim 1, further comprising end plates that are provided at opposite sides of the core and close the opposite sides of the core.

6. The rotor for the wound-rotor induction motor according to claim 5, wherein:
each of the anti-spattering members is formed with fixing protrusions at opposite sides thereof; and
each of the end plates is formed with insertion holes into which the fixing protrusions are inserted.

7. The rotor for the wound-rotor induction motor according to claim 6, wherein at least one of the insertion holes includes an expansion that expands to allow a molding material to be injected thereinto.

8. The rotor for the wound-rotor induction motor according to claim 1, wherein the base part has rotor weight holes formed in a surface thereof to adjust rotational balance of the rotor.
